(19) United States
(12) Patent Application Publication
(10) Pub. No.: US 2018/0301108 A1
(43) Pub. Date: Oct. 18, 2018

(54) DRIVING DEVICES OF DISPLAY PANELS AND DRIVING METHOD THEREOF

(71) Applicant: SHENZHEN CHINA STAR OPTOELECTRONICS TECHNOLOGY CO., LTD., Shenzhen Guangdong (CN)

(72) Inventors: Yu WU, Shenzhen, Guangdong (CN); Lei WANG, Shenzhen, Guangdong (CN)

(73) Assignee: SHENZHEN CHINA STAR OPTOELECTRONICS TECHNOLOGY CO., LTD., Shenzhen, Guangdong (CN)

(21) Appl. No.: 15/519,538

(22) PCT Filed: Feb. 15, 2017
(86) PCT No.: PCT/CN2017/073590

§ 371 Date: Apr. 15, 2017

(30) Foreign Application Priority Data
Dec. 28, 2016 (CN) 201611236662.4

(51) Int. Cl. G09G 3/36

(52) U.S. Cl. CPC G09G 3/3696; G09G 3/3685; G09G 2310/0251; G09G 2320/0233; G09G 2310/08; G09G 3/3674

(57) ABSTRACT

The present disclosure discloses a diving device and method of display panels. The driving device includes: a sequence control circuit configured to receive and analyze a current data frame to acquire frame turn-on signals to be outputted, and to generate pre-charge signals and scanning clock pulse signals according to the frame turn-on signals; a data line driving circuit configured to output first charge voltage signals to each data lines to perform a pre-charge process on a parasitic capacitance of each data lines when being controlled by the pre-charge signals, and to output second charge voltage signals to each data lines to charge each pixels row by row when being controlled by the scanning clock pulse signals. Via the method above, the present disclosure is capable of solving the uneven brightness problem of the pixels in the display panels caused by the data lines stored in the parasitic capacitance.

### BACKGROUND OF THE INVENTION

### 1. Field of the Invention

The present disclosure relates to liquid crystal display technology, and more particularly, to a driving device of display panels and a driving method thereof.

### 2. Discussion of the Related Art

In the traditional driving process of the display panels, image displaying requires charging the pixels of the display panels row by row. In the practical charging process, due to the great amount of parasitic capacitance in the whole data line and the negative charge stored in parasitic capacitance, the data line driving circuit configured in the display panels needs to extract a large current to pre-charge the parasitic capacitance of the data line. If the self-thrust of the data line drive circuit is insufficient, the charging voltage may be pulled down, so that the pixels of the positive polarity of the first few rows are insufficient, which leads to the darkness of the pixels of the positive polarity of these lines. When the parasitic capacitance of the data line is filled, the charging voltage outputted from the data line driving circuit may not be pulled down, so that the brightness of the pixels will maintain normal.

FIG. 1 is the schematic view of one conventional charging voltage varies with time. FIG. 2 is the schematic view of one conventional brightness distribution of each of the pixels. As shown in FIG. 1 and FIG. 2, in the charging cycle t1, t2, and t3 of the first, second, and third rows of the pixels, the charging voltage are pulled down, so that the brightness of the positive polarity pixels in the first, second, and third rows are dark; at the charging cycle of the fourth row and the subsequent rows of the pixels, the charging voltage V is normal, the brightness of each of the pixels in the fourth row and the subsequent pixels may maintain normal.

### SUMMARY

The present disclosure is to provide a driving device of display panels and a driving method thereof to solve the technical problem of uneven pixel brightness in the display panels.

In one aspect, a driving device of display panels, the driving device includes: a sequence control circuit configured to receive and analyze a current data frame to acquire frame turn-on signals to be outputted, and to generate pre-charge signals and scanning clock pulse signals according to the frame turn-on signals, wherein the pre-charge signals are outputted before the scanning clock pulse signals; a data line driving circuit configured to output first charge voltage signals to each of the data lines to perform a pre-charge process on a parasitic capacitance of each of the data lines when being controlled by the pre-charge signals, and to output second charge voltage signals to each data lines to charge each of the pixels row by row when being controlled by the scanning clock pulse signals; a scanning driving circuit configured to receive the scanning clock pulse signals to generate column scanning driving signals corresponding to each of the scanning lines, and output the column scanning driving signals to the scanning line, wherein the first charge voltage signals and the second charge voltage signals are pulse signals, a pulse width of the first charge voltage signals is greater than or equal to a pulse width of the second charge voltage signals.

Wherein the sequence control circuit further acquires pixel voltage signals corresponding to each of the pixels by analyzing the current data frame; the data line driving circuit configured to output the second charge voltage signals and the pixel voltage signals in sequence to each data lines to charge each of the pixels and to apply the corresponding pixel voltages on each of the pixels via the column scanning driving signals.

Wherein the sequence control circuit further generates data clock pulse signals according to the frame turn-on signals; the data line driving circuit further output the second charge voltage signals and the pixel voltage signals in sequence to each data lines when being controlled by the data clock pulse signals.

In another aspect, a driving device of display panels, the driving device includes: a sequence control circuit configured to receive and analyze a current data frame to acquire frame turn-on signals to be outputted, and to generate pre-charge signals and scanning clock pulse signals according to the frame turn-on signals, wherein the pre-charge signals are outputted before the scanning clock pulse signals; a data line driving circuit configured to output first charge voltage signals to each of the data lines to perform a pre-charge process on a parasitic capacitance of each of the data lines when being controlled by the pre-charge signals, and to output second charge voltage signals to each data lines to charge each of the pixels row by row when being controlled by the scanning clock pulse signals.

Wherein the driving device further includes a scanning driving circuit; the scanning driving circuit configured to receive the scanning clock pulse signals to generate column scanning driving signals corresponding to each of the scanning lines, and output the column scanning driving signals to the scanning line.

Wherein the sequence control circuit further acquires pixel voltage signals corresponding to each of the pixels by analyzing the current data frame; the data line driving circuit configured to output the second charge voltage signals and the pixel voltage signals in sequence to each data lines to charge each of the pixels and to apply the corresponding pixel voltages on each of the pixels via the column scanning driving signals.

Wherein the sequence control circuit further generates data clock pulse signals according to the frame turn-on signals; the data line driving circuit further output the second charge voltage signals and the pixel voltage signals in sequence to each data lines when being controlled by the data clock pulse signals.

Wherein the first charge voltage signals and the second charge voltage signals are pulse signals, a pulse width of the first charge voltage signals is greater than or equal to a pulse width of the second charge voltage signals.

In another aspect, a driving method, a driving method bases on a sequence control unit, a scanning driving circuit, and a data line driving circuit, the driving method includes: receiving and analyzing a current data frame by the sequence control circuit to acquire frame turn-on signals to be output; generating pre-charge signals and scanning clock pulse signals by the sequence control circuit according to the frame turn-on signals, wherein the pre-charge signals are outputted before the scanning clock pulse signals; outputting first charge voltage signals to each data lines to perform a pre-charge process on a parasitic capacitance of each data lines when being controlled by the pre-charge signals, and outputting second charge voltage signals to each data lines to charge each of the pixels row by row when being controlled by the scanning clock pulse signals.

Wherein the driving method further includes: receiving the scanning clock pulse signals by the scanning driving circuit to generate column scanning driving signals corresponding to each of the scanning lines, and outputting the column scanning driving signals to the scanning line.

Wherein the driving method further includes: acquiring pixel voltage signals by analyzing the current data frame via the sequence control circuit, and the pixel voltage signals corresponds to each of the pixels; a step of outputting the second charge voltage signals to each data lines by the data line driving circuit to charge each of the pixels row by row when being controlled by the scanning clock pulse signals comprises: outputting the second charge voltage signals and the pixel voltage signals by the data line driving circuit to each data lines to charge each of the pixels and to apply the corresponding pixel voltages on each of the pixels via the column scanning driving signals.

Where in the driving method further includes: generating data clock pulse signals by the sequence control circuit according to the frame turn-on signals; a step of out putting the second charge voltage signals and the pixel voltage signals in sequence by the data line driving circuit to each data line comprises: outputting the second charge voltage signals and the pixel voltage signals in sequence by the data line driving circuit to each data lines when being controlled by the data clock pulse signals.

Where in the first charge voltage signals and the second charge voltage signals are pulse signals, a pulse width of the first charge voltage signals is greater than or equal to a pulse width of the second charge voltage signals.

Compared to the conventional solution, the beneficial effect in the present disclosure resides in that: the driving device of the display panels and the method output first charge voltage signals to each of the data lines to perform a pre-charge process on a parasitic capacitance of each of the data lines when being controlled by the pre-charge signals, and to output second charge voltage signals to each data lines to charge each of the pixels row by row when being controlled by the scanning clock pulse signals. Via the method above, the present disclosure is capable of solving the uneven brightness problem of the pixels in the display panels caused by the data lines stored in the parasitic capacitance.

### BRIEF DESCRIPTION OF THE DRAWINGS

FIG. 1 is the schematic view of one conventional charging voltage varies with time.

FIG. 2 is the schematic view of one conventional brightness distribution of each of the pixels.

FIG. 3 is the schematic view of a driving device of display panels in a first embodiment of the present disclosure.

FIG. 4 is a waveform diagram showing the signals waveform of the driving device in FIG. 3 during an operation process.

FIG. 5 is the schematic view of the driving device of display panels of a second embodiment in the present disclosure.

FIG. 6 is a flowchart illustrating a driving method of the display panels in the first embodiment in the present disclosure.

FIG. 7 is a flowchart illustrating a driving method of the display panels in the second embodiment in the present disclosure.

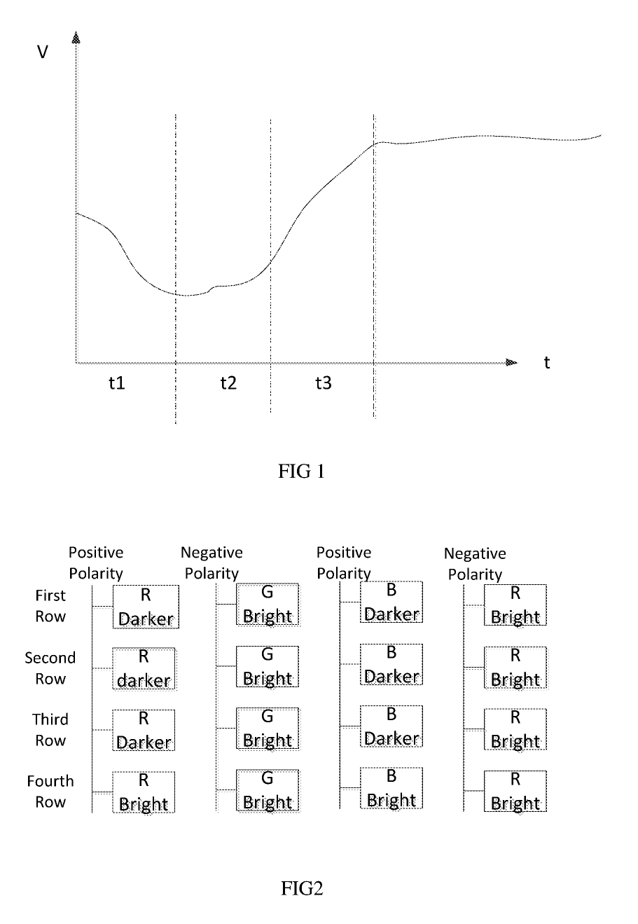

### DETAILED DESCRIPTION OF THE EMBODIMENTS

Some terms adapted in the description and claims refer to specific components. The person skilled in the art may understand the specific term, but the manufacturer may adapt different term to call the same component. Instead of using the difference between names as a way to distinguish components, the present description and claims use functional difference between components as criteria to distinguish components. The present disclosure will be described in detail with the following figures and embodiments.

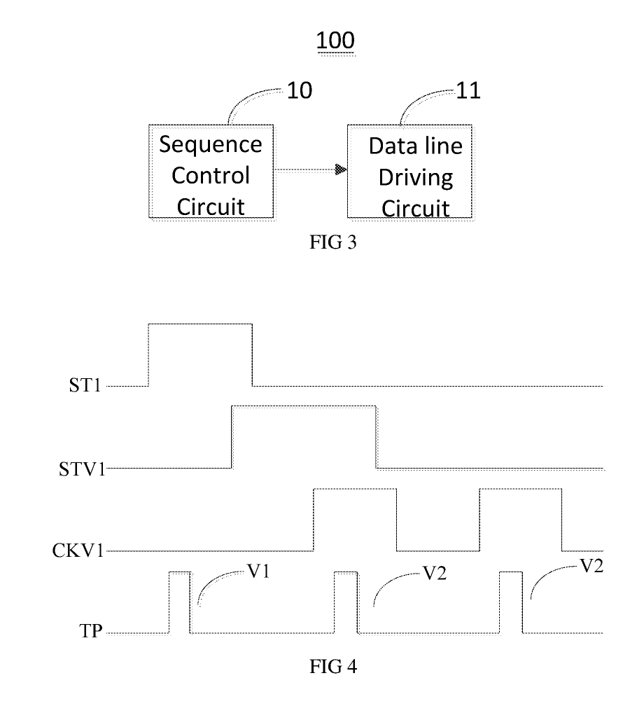

FIG. 3 is the schematic view of a driving device of display panels in a first embodiment of the present disclosure. As shown in FIG. 3, a driving device 100 includes a sequence control circuit 10 and a data line driving circuit 11.

The sequence control circuit 10 is configured to receive and analyze a current data frame to acquire frame turn-on signals to be outputted. The sequence control circuit 10 generates pre-charge signals and scanning clock pulse signals according to the frame turn-on signals, wherein the pre-charge signals are outputted before the scanning clock pulse signals.

In this embodiment, the pre-charge signals are outputted before the frame turn-on signals, the frame turn-on signals are outputted before the scanning clock pulse signals. In another point of view, when the pre-charge signals are valid, the frame turn-on signals are valid, and the scanning clock pulse signals are valid.

In another embodiment, the frame turn-on signals may be outputted before the pre-charge signals, and the pre-charge signals may be outputted before the scanning clock pulse signals.

The data line driving circuit 11 is configured to output first charge voltage signals to each of the data lines to perform a pre-charge process on a parasitic capacitance of each of the data lines when being controlled by the pre-charge signals, and to output second charge voltage signals to each of the data lines to charge each of the pixels row by row when being controlled by the scanning clock pulse signals.

FIG. 4 is a waveform diagram showing the signals waveform of the driving device in FIG. 3 during an operation process. As shown in FIG. 4, ST1 are the pre-charge signals, STV1 are the frame turn-on signals, CKV1 are the scanning clock pulse signals, TP are the signals applied on the data lines, wherein TP includes first charge voltage signals V1 and second charge voltage signals V2.

The pre-charge signals ST1 are outputted before the frame turn-on signals STV1, wherein the signals applied on data lines TP are the first charge voltage signals V1 when the pre-charge signals ST1 are valid.

At this time, because the frame turn-on signals STV1 and the scanning clock pulse signals CKV1 are in an invalid state, the first charge voltage signals V1 applied on the data lines may directly charge a parasitic capacitance of the data lines instead of charging each of the pixels.

Wherein the first charge voltage signals V1 are single positive voltage pulse signals having a pulse width corresponding to a size of the parasitic capacitance. Specifically, when the parasitic capacitance is greater than the first charge voltage signals V1, the positive voltage in the first charge voltage signals V1 will last longer; when the parasitic capacitance is smaller than the first charge voltage signals V1, the positive voltage in the first charge voltage signals V1 will last shorter.

Next, when the frame turn-on signals STV1 are valid, and the scanning clock pulse signals CKV1 are valid, the signals applied on data lines TP are the second charge voltage signals V2 charges each of the pixels row by row when being controlled by the scanning clock pulse signals CKV1. That is to say, in every pulse cycle of the scanning clock pulse signals CKV1, each of the data lines apply one corresponding second charge voltage signals V2 to charge one row of the pixels.

In one embodiment, the pulse width of the first charge voltage signals V1 are equal to a pulse width of the second charge voltage signals V2, a time interval between the first charge voltage signals V1 and the adjacent second charge voltage signals V2 are equal to a time interval between two adjacent second charge voltage signals V2. In another point of view, for convenience in practical, the first charge voltage signals V1 are one signals extended forward from the repeatedly arranged second charge voltage signals V2.

In another embodiment, the pulse width of the first charge voltage signals V1 may greater than the pulse width of the second charge voltage signals V2, the time interval between the first charge voltage signals V1 and the adjacent second charge voltage signals V2 may be arranged according to actual situation, as long as the first charge voltage signals V1 can satisfy the parasitic capacitance of each of the data lines.

FIG. 5 is the schematic view of the driving device of display panels of a second embodiment in the present disclosure. As shown in FIG. 5, a display panel 200 include a plurality of scanning lines Xm(m=1,2, . . . N) parallel to each other, a plurality of data lines Ym(m=1,2, . . . N)parallel to each other, and a plurality of pixels 210 arranged at the intersections of the scanning lines Xm and the data lines Ym.

Wherein, each of the pixels 210 includes a pixel field effect transistor T and a capacitance unit A(also called pixel electrode).The pixel field effect transistor T includes a gate G, a source S, and a drain D. The capacitance unit A includes a crystal capacitor Clc and a storage capacitor Cs arranged in parallel, and the crystal capacitor is also referred to as a pixel capacitance or a liquid crystal pixel. A side of the capacitance unit A is connected to the drain D, and the other side is connected to a common voltage Vcom. With respect to the pixels 210 arranged in the same row, the gate G of the pixel field effect transistor T is connected to the scanning lines Xm. Similarly, the source S of the pixel field effect transistor T within the pixels 210 arranged in the same row is connected to the data lines Ym.

The driving device 300 includes a sequence control circuit 30, a data line driving circuit 31, and a scanning line driving circuit 32. The data line driving circuit 31 is connected to the data lines Ym, and the scanning line driving circuit 32 is connected to the scanning lines Xm.

The sequence control circuit 30 is configured to receive and analyze a current data frame to acquire frame turn-on signals to be outputted and pixel voltage signals corresponding to each of the pixels, and to generate pre-charge signals ST2, scanning clock pulse signals CKV2, and data clock pulse signals CKL2.

The scanning line driving circuit 32 connects to the sequence control circuit 30, and configures to receive the scanning clock pulse signals CKV2 to generate column scanning driving signals Gm(m=1, 2, . . . n)corresponding to each of the scanning lines Xm, and to output the column scanning driving signals Gm to the scanning line Xm.

The data line driving circuit 31 connects to the sequence control circuit 30, and configures to output the first charge voltage signals V1 to each of the data lines Ym to perform a pre-charge process on the parasitic capacitance of each of the data lines Ym when being controlled by the pre-charge signals ST2, and to output the second charge voltage signals V2 and the pixel voltage signals to each data lines Ym to charge the drain D of each of the pixels or the capacitance unit A row by row via the column scanning driving signals Gm and to apply the corresponding pixel voltage when being controlled by the scanning clock pulse signals so as to display a current data frame.

In one embodiment, the pre-charge signals ST2 are outputted before the scanning clock pulse signals CKV2. That is to say, when the pre-charge signals ST2 are valid, the scanning clock pulse signals CKV2 are still in the invalid state, at this time, the gate G of each of the pixels is in turn-off state, the first charge voltage signals V1 are outputted to each of the data lines Ym to charge the parasitic capacitance of each of the data lines Ym.

When the scanning clock pulse signals CKV2 and the data clock pulse signals CKL2 are in valid state, a level of the scanning driving signals Gm applied on one row of the scanning line Xm by the scanning line driving circuit 32determine which row of the pixels 210 to be turned on or to be turned off; when the row of pixels are turn-on, the pixels 210 may receive the second charge voltage signals V2 and the pixel voltage signals applied on the data lines Ym of the row of the pixels 210 when being controlled by the data clock pulse signals CKL2 to charge the drain D or capacitance unit A, and to receive the pixel voltage which is necessary to display a corresponding grayscale, thereby to display a image picture corresponding to the grayscale when the row of the pixels 210 are driven by a voltage on the scanning line Xm and the data lines Ym, and to achieve normal display of the screen via the second charge voltage signals V2 written by the data lines Ym and the pixel voltage which is necessary to display the corresponding grayscale when turn on the scanning line Xm row by row.

In one embodiment, the first charge voltage signals V1 and the second charge voltage signals V2 are pulse signals, the pulse width of the first charge voltage signals is greater than or equal to the pulse width of the second charge voltage signals. That is to say, a charging time of each of the data lines Ym via the first charge voltage signals V1 are greater than the charging via the second charge voltage signals V2.

In one embodiment, the first charge voltage signals V1 and the second charge voltage signals V2 may have same voltage value. In other embodiment, the first charge voltage signals V1 and the second charge voltage signals V2 may have different voltage value.

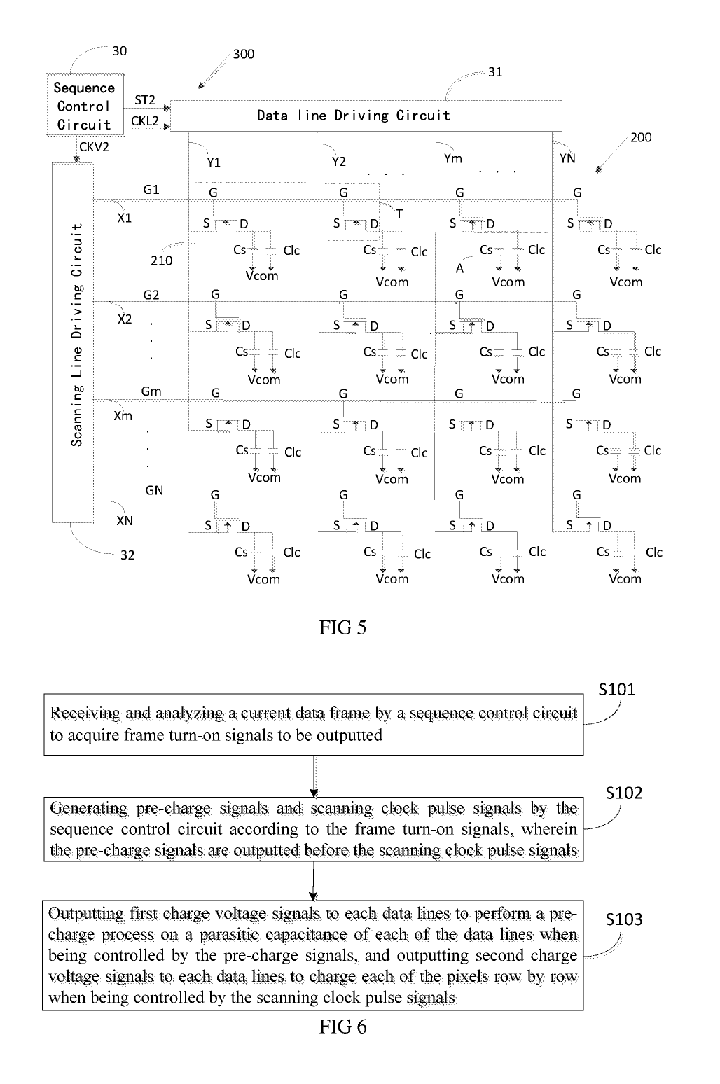

FIG. 6 is a flowchart illustrating a driving method of the display panels in the first embodiment in the present disclosure. The driving method basing on the driving device is shown in FIG. 3. Note that if there is a substantially same result, the driving method in the present disclosure is not limited to the process shown in FIG. 6. As shown in FIG. 6, the steps of the driving method include:

In Step S101: receiving and analyzing the current data frame by the sequence control circuit to acquire the frame turn-on signals STV1 to be output.

In Step S102: generating the pre-charge signals ST1 and the scanning clock pulse signals CKV1 by the sequence control circuit.

In Step S102, the pre-charge signals ST1 are outputted before the scanning clock pulse signals CKV1.

In Step S103: outputting the first charge voltage signals V1 to each data lines Ym to perform the pre-charge process on the parasitic capacitance of each data lines when being controlled by the pre-charge signals ST1, and outputting the second charge voltage signals V2 to each data lines Ym to charge each of the pixels 210 row by row when being controlled by the scanning clock pulse signals CKV1.

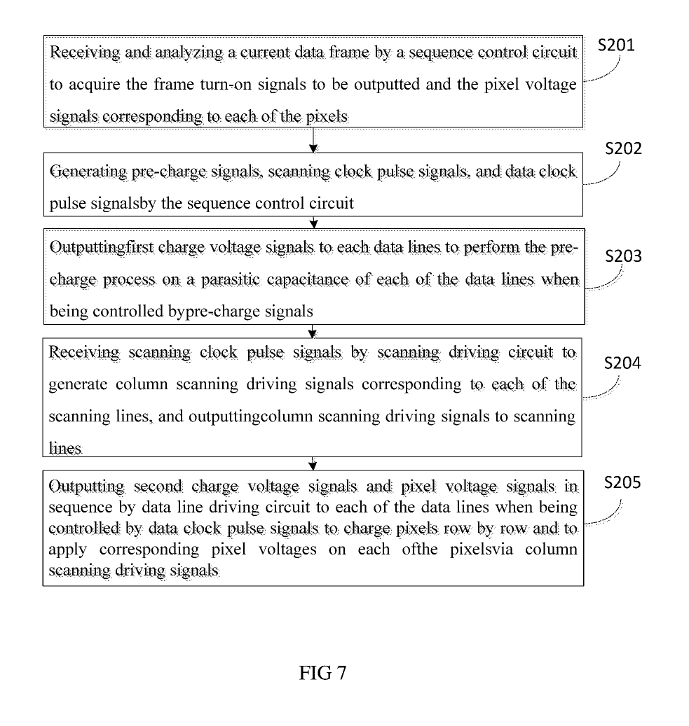

FIG. 7 is a flowchart illustrating a driving method of the display panels in the second embodiment in the present disclosure, the driving method bases on the driving device shown in FIG. 5. Note that if there is a substantially same result, the driving method in the present disclosure is not limited to the process shown in FIG. 7. As shown in FIG. 7, the steps of the driving method include:

In Step S201: receiving and analyzing the current data frame by the sequence control circuit to acquire the frame turn-on signals STV1 to be outputted and the pixel voltage signals corresponding to each of the pixels 210.

In Step S202: generating the pre-charge signals ST2, the scanning clock pulse signals CKV2, and the data clock pulse signals CKL2 by the sequence control circuit 30.

In Step S202, the pre-charge signals ST2 are outputted before the scanning clock pulse signals CKV2. Specifically, the pre-charge signals ST2 are outputted before the frame turn-on signals STV1, the frame turn-on signals STV1 are outputted before the scanning clock pulse signals CKV2.

In Step S203: outputting the first charge voltage signals V1 to each data lines Ym to perform the pre-charge process on a parasitic capacitance of each data lines Ym when being controlled by the pre-charge signals ST2.

In Step S203, when the pre-charge signals ST2 are outputted before the scanning clock pulse signals CKV2, such that each of the data lines in the display panels are applied by the first charge voltage signals V1, because the frame turn-on signals STV1 and the scanning clock pulse signals CKV2 are in the invalid state, the first charge voltage signals V1 applied on the data lines Ym may directly charge the parasitic capacitance of the data lines Ym instead of charging each of the pixels 210.

In Step S204: receiving the scanning clock pulse signals CKV2 by the scanning driving circuit to generate the column scanning driving signals Gm corresponding to each of the scanning lines Xm, and outputting the column scanning driving signals Gm to the scanning lines Xm.

In Step S205: outputting the second charge voltage signals V2 and the pixel voltage signals in sequence by the data line driving circuit 11 to each data lines Ym when being controlled by the data clock pulse signals CKL2 to charge the pixels 210 row by row and to apply the corresponding pixel voltages on each of the pixels 210 via the column scanning driving signals Gm.

In Step S205, the first charge voltage signals V1 and the second charge voltage signals V2 are pulse signals, the pulse width of the first charge voltage signals V1 are greater than or equal to the pulse width of the second charge voltage signals V2.

Compared to the conventional solution, the beneficial effect in the present disclosure resides in that: the driving device of the display panels and the method outputs first charge voltage signals to each of the data lines to perform a pre-charge process on a parasitic capacitance of each of the data lines when being controlled by the pre-charge signals, and to output second charge voltage signals to each data lines to charge each of the pixels row by row when being controlled by the scanning clock pulse signals. Via the method above, the present disclosure is capable of solving the uneven brightness problem of the pixels in the display panels caused by the data lines stored in the parasitic capacitance.

The above description is only the embodiments in the present disclosure, the claim is not limited to the description thereby. The equivalent structure or changing of the process of the content of the description and the figures, or to implement to other technical field directly or indirectly should be included in the claim.

What is claimed is:

1. A driving device of display panels, comprising:
a sequence control circuit configured to receive and analyze a current data frame to acquire frame turn-on signals to be outputted, and to generate pre-charge signals and scanning clock pulse signals according to the frame turn-on signals, wherein the pre-charge signals are outputted before the scanning clock pulse signals;
a data line driving circuit configured to output first charge voltage signals to each of the data lines to perform a pre-charge process on a parasitic capacitance of each of the data lines when being controlled by the pre-charge signals, and to output second charge voltage signals to each of the data lines to charge each of the pixels row by row when being controlled by the scanning clock pulse signals;
a scanning driving circuit configured to receive the scanning clock pulse signals to generate column scanning driving signals corresponding to each of the scanning lines, and output the column scanning driving signals to the scanning line;
wherein the first charge voltage signals and the second charge voltage signals are pulse signals, and a pulse width of the first charge voltage signals is greater than or equal to a pulse width of the second charge voltage signals.

2. The driving device according to claim 1, wherein the sequence control circuit further acquires pixel voltage signals corresponding to each of the pixels by analyzing the current data frame; the data line driving circuit configured to output the second charge voltage signals and the pixel voltage signals in sequence to each of the data lines to charge each of the pixels and to apply the corresponding pixel voltages on each of the pixels via the column scanning driving signals.

3. The driving device according to claim 2, wherein the sequence control circuit further generates data clock pulse signals according to the frame turn-on signals;
the data line driving circuit further outputs the second charge voltage signals and the pixel voltage signals in sequence to each of the data lines when being controlled by the data clock pulse signals.

4. A driving device of display panels, comprising:
a sequence control circuit configured to receive and analyze a current data frame to acquire frame turn-on signals to be outputted, and to generate pre-charge signals and scanning clock pulse signals according to the frame turn-on signals, wherein the pre-charge signals are outputted before the scanning clock pulse signals;
a data line driving circuit configured to output first charge voltage signals to each of the data lines to perform a pre-charge process on a parasitic capacitance of each of the data lines when being controlled of the pre-charge signals, and to output second charge voltage signals to each of the data lines to charge each of the pixels row by row when being controlled by the scanning clock pulse signals.

5. The driving device according to claim 4, wherein the driving device further comprises a scanning driving circuit; the scanning driving circuit configured to receive the scanning clock pulse signals to generate column scanning driving signals corresponding to each of the scanning lines, and to output the column scanning driving signals to the scanning line.

6. The driving device according to claim 5, wherein the sequence control circuit further acquires pixel voltage signals corresponding to each of the pixels by analyzing the current data frame;
the data line driving circuit configured to output the second charge voltage signals and the pixel voltage signals in sequence to each of the data lines to charge each of the pixels and to apply the corresponding pixel voltages on each of the pixels via the column scanning driving signals.

7. The driving device according to claim 6, wherein the sequence control circuit further generates data clock pulse signals according to the frame turn-on signals;
the data line driving circuit further output the second charge voltage signals and the pixel voltage signals in sequence to each of the data lines when being controlled by the data clock pulse signals.

8. The driving device according to claim 4, wherein the first charge voltage signals and the second charge voltage signals are pulse signals, a pulse width of the first charge voltage signals is greater than or equal to a pulse width of the second charge voltage signals.

9. A driving method of display panels, wherein the driving method bases on a driving device of the display panel, the driving device comprises a sequence control circuit and a data line driving circuit, the driving method of the display panels comprising:
receiving and analyzing a current data frame by the sequence control circuit to acquire frame turn-on signals to be outputted;
generating pre-charge signals and scanning clock pulse signals by the sequence control circuit according to the frame turn-on signals, wherein the pre-charge signals are outputted before the scanning clock pulse signals;
outputting first charge voltage signals to each of the data lines to perform a pre-charge process on a parasitic capacitance of each of the data lines when being controlled by the pre-charge signals, and outputting second charge voltage signals to each of the data lines to charge each of the pixels row by row when being controlled by the scanning clock pulse signals.

10. The driving method according to claim 9, wherein the driving device further comprises a scanning driving circuit, the driving method further comprises:
receiving the scanning clock pulse signals by the scanning driving circuit to generate column scanning driving signals corresponding to each of the scanning lines, and outputting the column scanning driving signals to the scanning line.

11. The driving method according to claim 10, wherein the driving method further comprises:
acquiring pixel voltage signals by analyzing the current data frame via the sequence control circuit, and the pixel voltage signals corresponds to each of the pixels;
the step of outputting the second charge voltage signals to each of the data lines by the data line driving circuit to charge each of the pixels row by row when being controlled by the scanning clock pulse signals further comprises:
outputting the second charge voltage signals and the pixel voltage signals by the data line driving circuit to each of the data lines to charge each of the pixels and to apply the corresponding pixel voltages on each of the pixels via the column scanning driving signals.

12. The driving method according to claim 11, wherein the driving method further comprises:
Generating data clock pulse signals by the sequence control circuit according to the frame turn-on signals;
the step of outputting the second charge voltage signals and the pixel voltage signals in sequence by the data line driving circuit to each of the data line comprises:
outputting the second charge voltage signals and the pixel voltage signals in sequence by the data line driving circuit to each of the data lines when being controlled by the data clock pulse signals.

13. The driving method according to claim 9, wherein the first charge voltage signals and the second charge voltage signals are pulse signals, and a pulse width of the first charge voltage signals is greater than or equal to a pulse width of the second charge voltage signals.
